(19) United States
(12) Patent Application Publication
(10) Pub. No.: US 2026/0167105 A1
(43) Pub. Date: Jun. 18, 2026

(54) SYSTEMS AND METHODS FOR IMPROVING VEHICLE VISIBILITY

(71) Applicant: Ford Global Technologies, LLC, Dearborn, MI (US)

(72) Inventors: RAMI AL KHATIB, Dearborn, MI (US); Mansoor Nasir, Canton, MI (US); Mahmoud Yousef Ghannam, Canton, MI (US)

(73) Assignee: Ford Global Technologies, LLC, Dearborn, MI (US)

(21) Appl. No.: 18/981,588

(22) Filed: Dec. 15, 2024

(51) Int. Cl. B60Q 7/00; B60Q 1/50; B64U 70/00; B64U 101/45; B64U 101/55; G07C 5/08; G08G 1/0955

(52) U.S. Cl. CPC B60Q 7/005; B60Q 1/543; B64U 70/00; G07C 5/0825; B64U 2101/45; B64U 2101/55; G08G 1/0955

(57) ABSTRACT

Systems and methods for improving visibility of a vehicle at night, at a location, and/or under certain weather conditions are provided. The vehicle includes a visual alert system that can deploy one or more visual alert mechanisms to enhance the visibility of the vehicle. In an instance where the vehicle becomes disabled while on a road for any reason, the vehicle can determine the nature and reason for the disability. The vehicle can also determine the severity of the incident that caused the vehicle to be disabled, current time, weather, and location data. Based on this information, the vehicle determines which visual alert mechanism is to be deployed and whether one or more visual alert mechanisms are to be deployed. The vehicle then deploys the appropriate type and number of visual alert mechanism in order to enhance the visibility of the vehicle to drivers of other vehicles on the road.

### FIELD

The present disclosure relates to the field of vehicle visibility. Specifically, embodiments of the present disclosure relate to systems and methods for improving a vehicle's visibility at night and under certain weather conditions.

### BACKGROUND

Vehicle visibility at night and under certain weather conditions can be of concern. “Vehicle visibility’ refers to the ability of drivers on the road to clearly see any stalled or disabled vehicles that may be blocking any part of the road. At night, the absence of natural light reduces a driver's ability to see the road, obstacles, and other vehicles clearly. Headlights often provide insufficient illumination, especially on poorly lit roads. Additionally, glare from oncoming traffic can further impair a driver's vision and reduce his/her ability to clearly see objects on the road or the road itself. Weather conditions such as fog, rain, and snow may exacerbate these issues. Fog scatters light, creating a whiteout effect that makes it difficult to judge distances and see road markings. Rain can cause reflections and glare while also reducing the effectiveness of headlights and taillights. Snow not only reduces visibility but can also obscure road signs and lane markings. These conditions demand heightened alertness and slower driving speeds.

If one or more vehicles become disabled for any reason while on a road, the driver of the vehicle(s) may need to pull over to inspect the issue. Sometimes, the vehicle may become inoperable and cannot be moved due to the nature of the disability. In these situations, one or more first response teams such as police, paramedics, and/or fire department, may need to arrive at the scene to assist the vehicle and/or its occupants. During the time the first response teams are enroute, other vehicles/drivers on that road need to be alerted of the presence of the disabled vehicle(s). While some systems, such as hazard lights, reflective triangles, flares, etc., currently exist to alert other drivers of the presence of a disabled vehicle, these systems may not be operational at the time of the incident.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates a high-level flow chart of a process for improving visibility of a vehicle according to an embodiment of the present disclosure.

FIGS. 4A and 4B illustrate a visual alert mechanism according to an embodiment of the present disclosure.

FIGS. 5A-5C illustrate a visual alert mechanism for a vehicle according to another embodiment of the present disclosure.

FIGS. 6A and 6B illustrate a visual alert mechanism for a vehicle according to yet another embodiment of the present disclosure.

FIGS. 7A-7C illustrate another visual alert mechanism according to an embodiment of the present disclosure.

FIG. 8 illustrates a flow chart for a process for improving the visibility of a vehicle according to an embodiment of the present disclosure.

FIG. 9 illustrates a block diagram of a server according to an embodiment of the present disclosure.

### DETAILED DESCRIPTION

### Overview

The present disclosure describes systems and methods for improving visibility of a vehicle that may be disabled and present on or along a road. The increased visibility of the disabled vehicle may assist other drivers in adjusting their driving patterns to avoid contact with the disabled vehicle.

Embodiments of the present disclosure provide a method performed by a vehicle for improving the visibility of the vehicle. The method includes the vehicle determining that the vehicle is in a disabled state on a road. The vehicle further determines a time of the day and data associated with a current location of the vehicle. Thereafter, the method further includes the vehicle determining a first visual alert mechanism to be deployed, from among a plurality of visual alert mechanisms based on the time of the day and the location data and activating, by the first visual alert mechanism.

In another instance, a vehicle is provided that includes one or more processors, a memory device coupled to the one or more processors, and a visual alert system coupled to the one or more processors. The memory device stores instructions that, when executed by the one or processors, cause the vehicle to determine that the vehicle is in a disabled state on a road, determine a time of the day, and determine location data associated with current location of the vehicle. The vehicle is further operable to determine, via the visual alert system and based on the disabled state, the time of the day, and the location data, that a first visual alert mechanism to be activated and activate the first visual alert mechanism.

In yet another instance, a method for improving the visibility of a vehicle is provided. The method includes the vehicle determining that the vehicle is in a disabled state. The method further includes the vehicle determining location data associated with a current location of the vehicle and a time of the day. The method further includes the vehicle selecting a first visual alert mechanism, from among a plurality of visual alert mechanisms of the vehicle. The selection is done based on the disabled state, the location data, and the time of the day. The plurality of visual alert mechanisms includes (i) one or more light emitting devices coupled to the vehicle that does not derive power from the vehicle, (ii) a fluorescent material stored at one or more locations within the vehicle, or (iii) one or more unmanned aerial vehicles stored in the vehicle. The method further comprises the vehicle activating the first visual alert mechanism.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

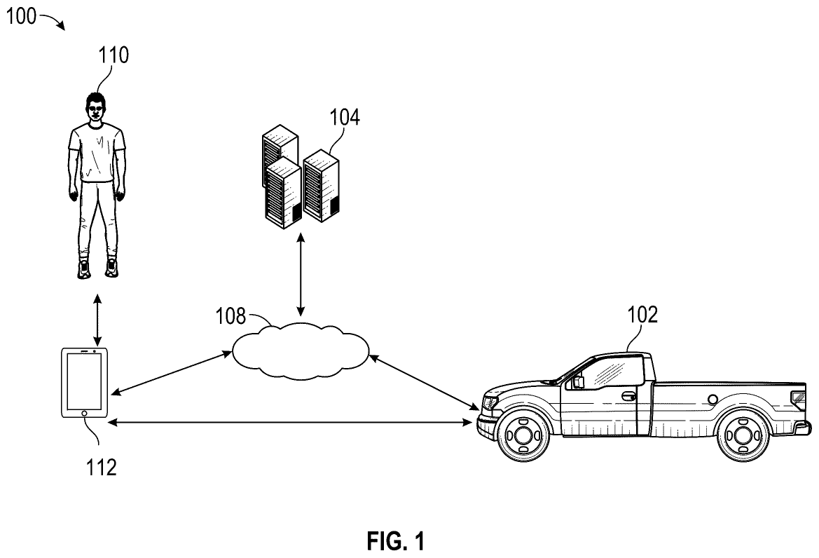

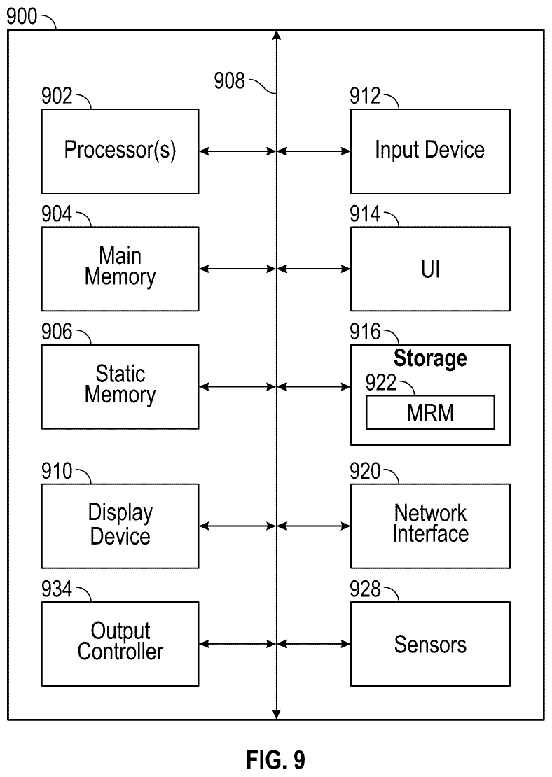

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 9.

The environment 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

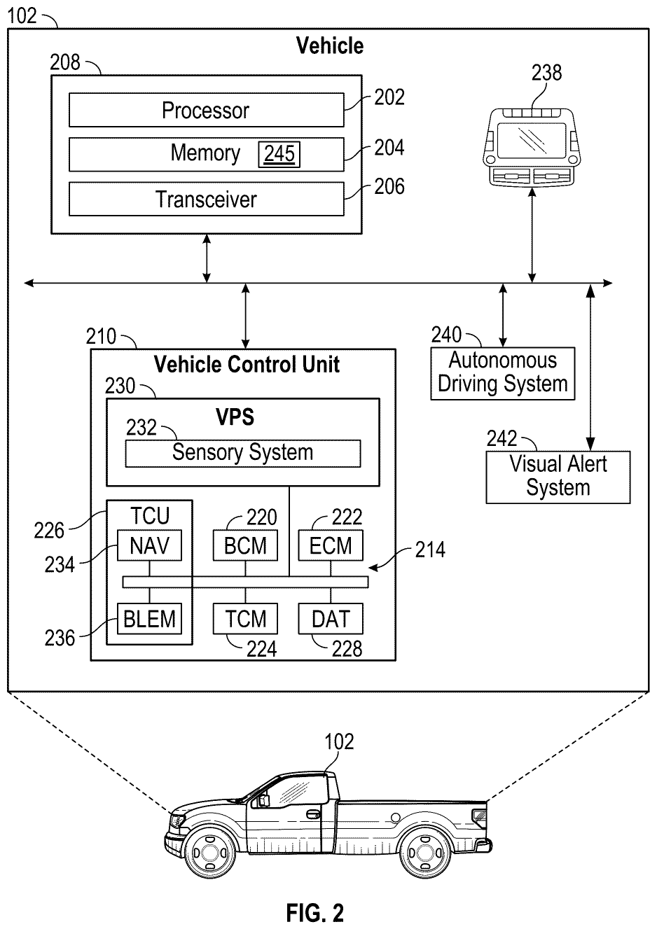

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc., or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features and biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc., on the touchscreen interface portion. In some embodiments, the user device 112 may provide the HMI interface.

In some embodiments, the vehicle 102 may include a visual alert system 242. The visual alert system 242 may receive input from the vehicle control unit 210 indicating that the vehicle is disabled and reason for the disablement (e.g., mechanical breakdown, involved in an incident, etc.). Based on the input, the vehicle alert system may deploy one or more mechanisms that help to improve the visibility of the vehicle 102. In an embodiment, the visual alert system 242 may include a fluorescent material and deployment mechanism, one or more devices that emit light, one or more unmanned aerial vehicles (UAV), a tethered fluorescent balloon, and/or the like. The visual alert system 242 may be coupled to any external surface of the vehicle 102 or may be disposed within the vehicle 102.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle stopping system that allows the driver to slow down or stop the vehicle 102. It includes components like pedals, master cylinder, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All of the mechanical components working together ensure that the vehicle 102 operates optimally.

As noted above, a vehicle's visibility for other drivers on a road may be reduced due to the time of the day and/or weather and other conditions. Normally, if a vehicle becomes disabled for any reason, one or more first responder teams may be alerted and deployed to assist the vehicle and/or the occupants of the vehicle. The first response teams may include tow-truck, police, paramedics, and/or fire departments. During the time of the breakdown/disablement of the vehicle and the arrival of the first responders at the location of the vehicle, it is important to ensure that the vehicle and/or its occupants are clearly visible to the drivers of other vehicles on the road so that the drivers of the other vehicles can adjust their driving pattern and avoid any further contact with the disabled vehicle. Clear visual demarcation of the disabled vehicle can be especially challenging at night and under adverse weather conditions like rain, fog, snow, etc., when there is reduced visibility.

Embodiments of the present disclosure provide systems and methods that improve a vehicle's visibility under such (and other) conditions and provide a robust way of identifying the location and/or orientation of the disabled vehicle to help other drivers on the road.

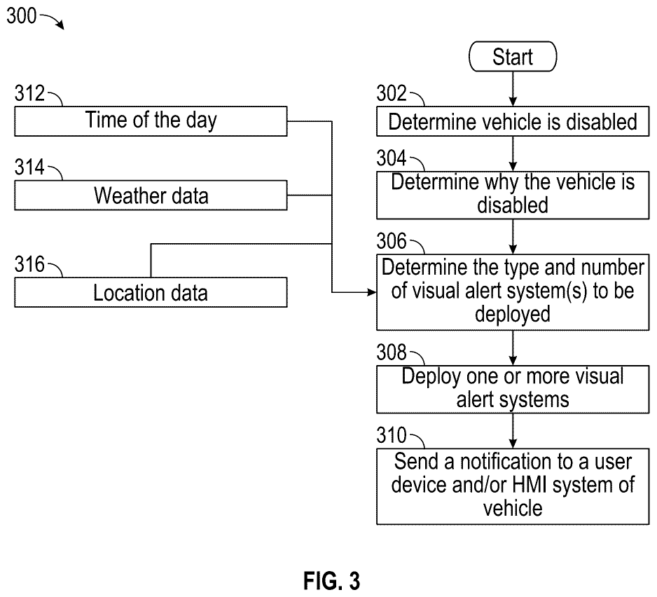

FIG. 3 is a high-level flow chart of a process 300 for improving visibility of a vehicle according to an embodiment of the present disclosure. Process 300 may be performed by the vehicle 102 alone or by the vehicle 102 in conjunction with the server 104. At step 302, the vehicle may determine that the vehicle is disabled. For example, one or more components of the vehicle control unit may determine that the vehicle is disabled. In an embodiment, data from the vehicle Controller Area Network (CAN) bus may indicate one or more issues with the vehicle. The vehicle may be disabled for several reasons. In an embodiment, the vehicle may become disabled due to a mechanical or electrical issue with one or more of its components. In another embodiment, the vehicle may become disabled due to physical contact with another vehicle. In such an instance, an incident detection system of the vehicle (e.g., a restraints control module (RCM)) may determine that the vehicle has had physical contact with one or more objects and one or more of the vehicle safety systems have been deployed. The one or more objects may include other vehicle(s), light poles, road dividers, or the like. At step 304, the vehicle may determine the reason behind the disablement of the vehicle. The data received from the vehicle control unit or the CAN bus may be used to determine the reason behind the disablement of the vehicle.

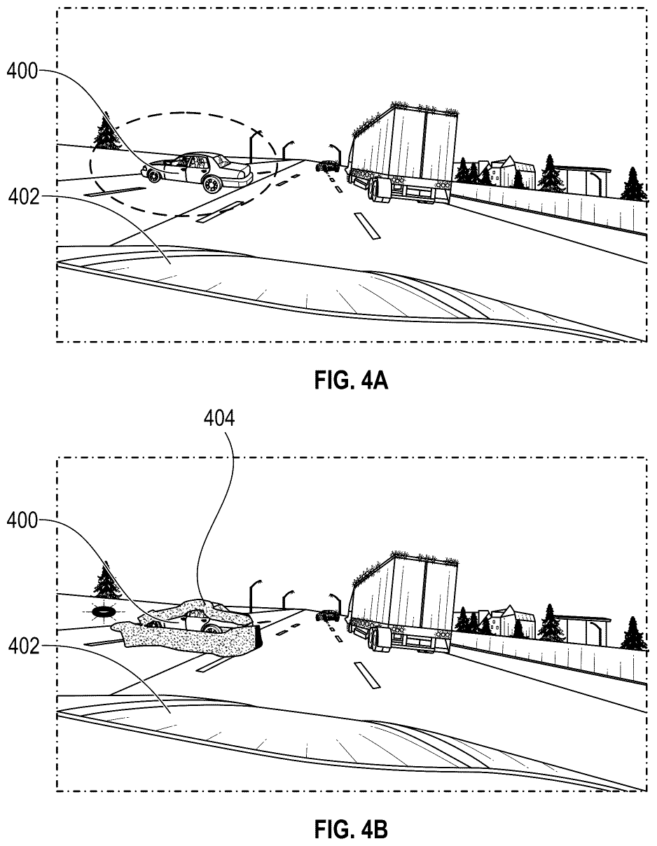

At step 306, the vehicle may determine (e.g., via the visual alert system 242), based on the reason and nature of the disablement, which of a multitude of visual alert mechanisms are to be deployed and whether one or more of the visual alert mechanisms are to be deployed. The details of the various visual alert mechanisms are provided below with reference to FIGS. 4-7. In an embodiment, the time of the day information 312 may also be used in determining which type of visual alert mechanism is to be deployed. For example, if the time of the day information 312 indicates it is night, then a visual alert mechanism that uses some form of emitted light may be used to enhance the vehicle's visibility. In another embodiment, weather data 314 may also be used to determine which type of visual alert mechanism is to be deployed. In an embodiment, more than one instance of the same visual alert mechanism may be deployed. For example, multiple self-powered lights, which may be coupled to various portions of the vehicle, may be activated. In another embodiment, two or more different types of visual alert mechanisms may be deployed. For example, the vehicle may activate one or more self-powered lights and deploy a fluorescent material to cover one or more portions of the vehicle and/or the ground in the vicinity of the vehicle. In some embodiments, location data 316 of the location at which the vehicle 102 is disabled may also be considered in determining the type and number of visual alert mechanisms to be deployed at step 306. For instance, the location data 316 may indicate that the vehicle is located at or near a bend in the road (or the vehicle may be obscured from view due to one or more objects) that may make the vehicle difficult to detect by other drivers on the road. In this instance, even if the time of day and the weather data may not warrant deployment of a visual alert mechanism (e.g., it is noon on a bright sunny day), the vehicle 102 may still deploy one or more visual alert mechanisms in order to improve the visibility of the vehicle. Thus, the decision to deploy a specific type and/or the number of visual alert mechanisms is an interplay between nature and reason for the disability, time of the day, weather data, and location data.

At step 308, the type of the visual alert mechanism and the number of visual alert mechanisms determined at step 306 are deployed by the vehicle. Once deployed, the visual alert mechanism(s) enhances the visibility of the vehicle and alerts the other drivers on the road of the vehicle's presence.

As noted above, the visual alert system 242 may include one or more mechanisms that help to improve or enhance the visibility of the vehicle 102. FIGS. 4A and 4B illustrate a visual alert mechanism according to an embodiment of the present disclosure. Consider a vehicle 400 that is present on a road and is disabled and is night-time at the location. In an embodiment, the vehicle 400 can be implemented using vehicle 102 of FIG. 1. Another vehicle 402 may also be moving along the same road as the vehicle 400. Even though the vehicle 402 may have its headlights turned on, it may be difficult for the driver of the vehicle 402 to determine the exact orientation and location of the vehicle 400. In this instance, after the vehicle 400 is disabled, the vehicle 400 may determine the cause of the disablement, the time of the day, and the current weather condition. Based on this information, the vehicle 400 may deploy a fluorescent material 404 that covers one or more external portions of the vehicle 400 and/or a portion of the ground in the immediate vicinity of the vehicle. In an embodiment, the fluorescent material may include zinc sulfide or strontium aluminate. In other embodiments, the fluorescent material may include fluorite or materials that use chemiluminescence (e.g., Luminol, Oxalate Esters, hydrogen peroxide, Ruthenium Complexes, Potassium Permanganate) to produce light. The fluorescent material may be stored in one or more locations of the vehicle. In an embodiment, if the vehicle 400 detects physical contact with another vehicle, the visual alert system 242 may receive a signal that causes the visual alert system 242 to release the fluorescent material 404 from its storage location. The fluorescent material 404 may be deployed such that it may partially cover one or more external surfaces of the vehicle 400 and/or an area on the ground next to the vehicle. The fluorescent material thus deployed then enhances the profile/visibility of the vehicle 400, making the vehicle 400 stand out in the environment. This helps the driver of the vehicle 402 to easily identify the presence and orientation of the vehicle 400 and take the necessary actions to adjust his/her driving pattern.

In other embodiments, the fluorescent material may be released such that the material is deposited around a periphery of the vehicle 400, effectively delineating the contours and orientation of the vehicle 400. This enables other drivers on the road to accurately determine the position and orientation of the vehicle 400. In some embodiments, if the vehicle 400 is unable to automatically deploy the fluorescent material 404 for any reason, such as power loss, the driver of the vehicle 400 can manually deploy the fluorescent material 404.

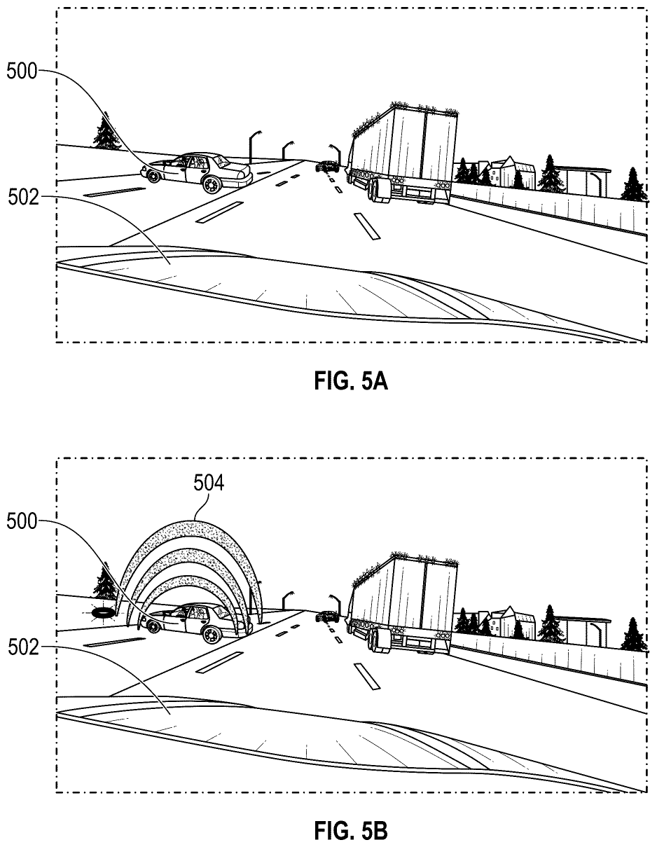

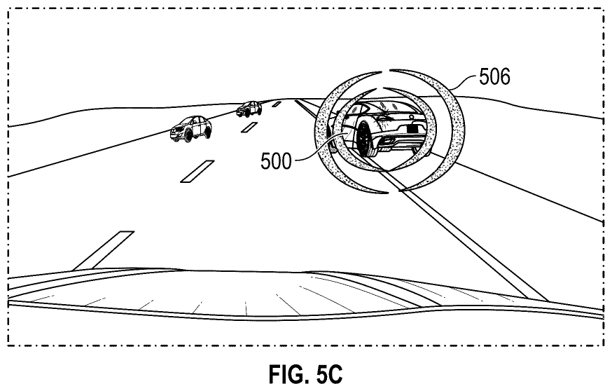

FIGS. 5A-5C illustrates a visual alert mechanism for a vehicle 500 according to another embodiment of the present disclosure. In this embodiment, the vehicle 500 may include one or more light emitting devices coupled to one or more external surfaces of the vehicle 500. In an embodiment, the vehicle 500 can be implemented using vehicle 102 of FIG. 1. The light emitting devices may include halogen lights, light emitting diodes (LEDs), Organic light emitting diodes (OLEDs), compact fluorescent bulbs (CFL), Laser diodes, gas lasers, solid-state lasers, fiber lasers, and the like. The light emitting devices may be self-powered by one or more power sources, such as a battery or a capacitor. In the instance where the vehicle 500 is disabled resulting in loss of all power to the vehicle 500, these light emitting devices may still operate using their dedicated battery or capacitor.

If the vehicle 500 becomes disabled for any reason, the vehicle may determine the cause and severity of the disability and activate one or more of the light emitting devices. In an embodiment, the light emitting devices may direct light in a pattern 504 where light is directed away from the vehicle in one more directions, as illustrated in FIG. 5B. In another embodiment, the light emitting devices may output light in a different pattern 506 that creates a “halo” effect around the vehicle as illustrated in FIG. 5C. In other embodiments, the light emitted by the one or more light emitting devices of the vehicle 500 may be placed such that the light emanating from them “lights up” the vehicle such that vehicle is visible from a distance. Regardless of the pattern in which the light is emitted by the light emitting devices, the emitted light enhances the visibility of the vehicle 500 such that a driver of another vehicle 502 driving along the same road can easily spot the vehicle 500.

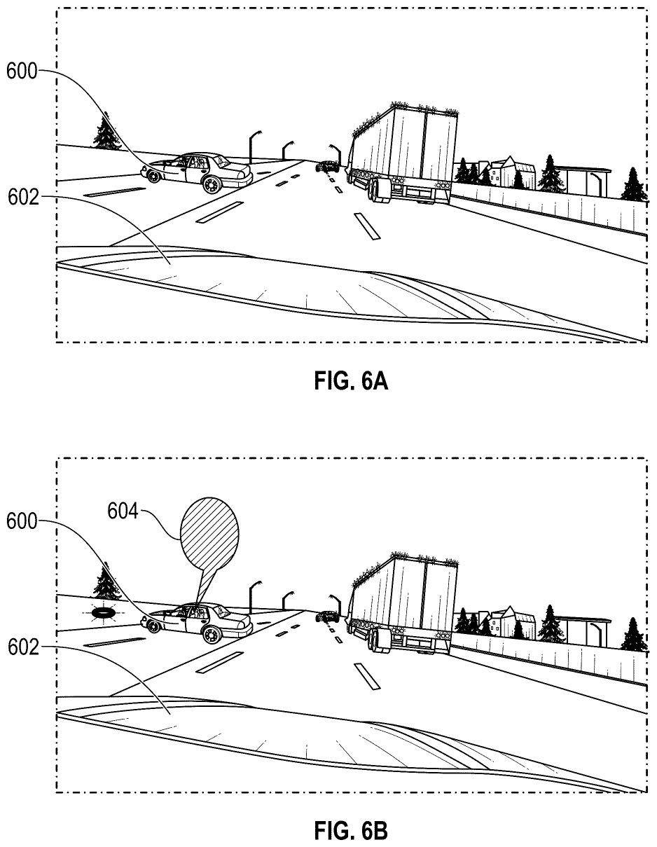

FIGS. 6A and 6B illustrate a visual alert mechanism according to yet another embodiment of the present disclosure. In this embodiment, the visual alert system 242 of the vehicle 600 may be equipped with a tethered fluorescent balloon 604. In an embodiment, the vehicle 600 can be implemented using vehicle 102 of FIG. 1. In this instance, if the vehicle 600 determines that it is disabled, the vehicle 600 may deploy the tethered fluorescent balloon 604. The tethered fluorescent balloon 604 may then hover over the vehicle 600 and provide a visual indication of the presence of the vehicle 600. Thus, a driver of any other vehicle 602 driving along the same road will be able to easily spot the vehicle 600. The presence of the tethered fluorescent balloon 604 greatly enhances the visibility of the vehicle 600.

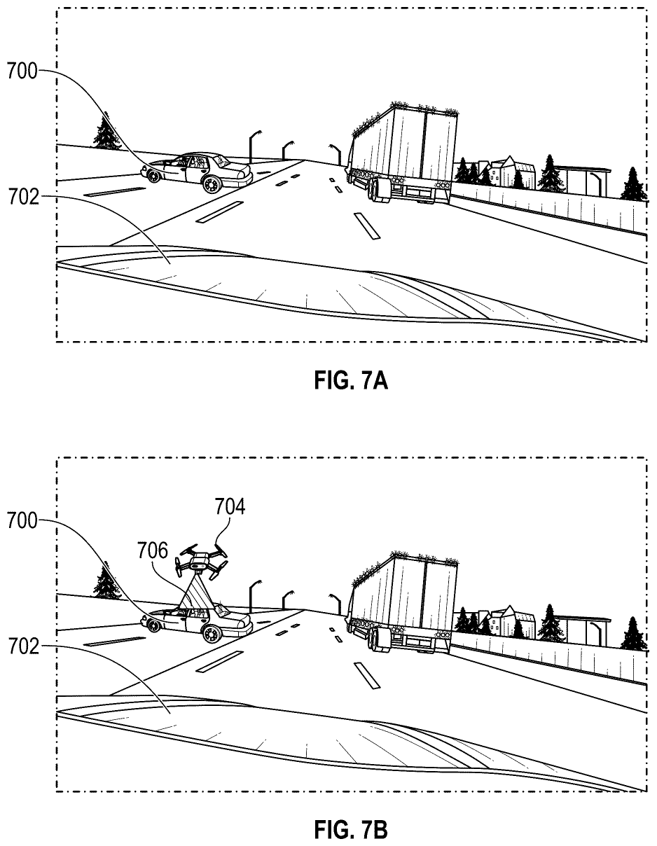

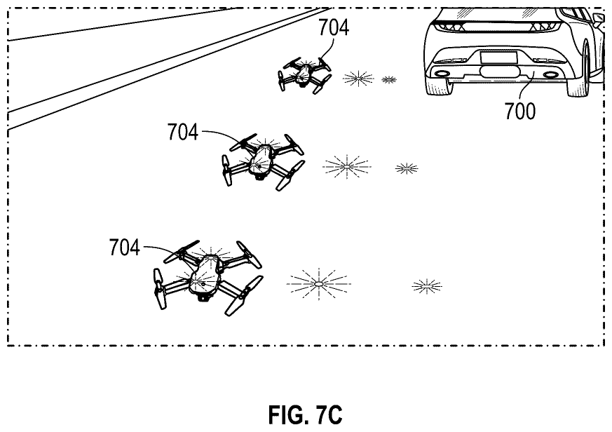

FIGS. 7A-7C illustrate another type of visual alert mechanism according to an embodiment of the present disclosure. In this embodiment, one or more unmanned aerial vehicles (UAVs) 704 are used to enhance the visibility of the vehicle 700. In an embodiment, the vehicle 700 can be implemented using vehicle 102 of FIG. 1. In an embodiment, the unmanned aerial vehicles are located within the vehicle 700 or otherwise integrated with the vehicle 700. In an embodiment, the one or more unmanned aerial vehicles 704 may be stored in the trunk of the vehicle 700. The unmanned aerial vehicle 704 may include one or more light emitting devices capable of outputting light in the entire visible spectrum. The unmanned aerial vehicle 704 may further include a flight controller, electronic speed controller, battery, one or more sensors, communication system, and navigation system. The unmanned aerial vehicle 704 may include a frame, motor(s), propellers, landing gear, and gimbals to enable the unmanned aerial vehicle 704 to fly.

In an embodiment, if the vehicle 700 is disabled, the vehicle may deploy one or more unmanned aerial vehicles 704. One of the unmanned aerial vehicles 704 may be positioned above the vehicle 700 and output light 706 that focuses on the vehicle 700, as illustrated in FIG. 7B. The unmanned aerial vehicle 704 may hover over the vehicle 700 and illuminate the vehicle 700 with light 706 until arrival of a first responder entity at the location. Once at least one first responder entity arrives at the location of the vehicle 700, the unmanned aerial vehicle 704 and/or the vehicle 700 may detect presence of the first responder entity and turn off the light and/or otherwise power down the unmanned aerial vehicle 704. Until the arrival of the first responder entity, the unmanned aerial vehicle 704 may continue to hover over the vehicle 706 and illuminate the vehicle such that a driver of any other vehicle 702 traveling along the same road can easily spot the vehicle 700. In another embodiment, the unmanned aerial vehicle 704 may be remotely triggered or activated (e.g., by the server 104) based on a message sent by the vehicle 700.

In some embodiments, multiple unmanned aerial vehicles 704 may be included in the vehicle. In this instance, even if some of the multiple unmanned aerial vehicles 704 are not deployable due to any reason (e.g., damaged in the incident, obstructed, etc.), at least one of the remaining unmanned aerial vehicles 704 may be deployed. All of these multiple unmanned aerial vehicles 704 are stored in the vehicle 700. In an embodiment, each of the unmanned aerial vehicles 704 may also include one or more internal light emitting devices that enable the unmanned aerial vehicles 704 to be self-illuminated such that they are visible from a distance. In one embodiment, in response to the vehicle 700 being disabled, two or more unmanned aerial vehicles 704 may be deployed by the vehicle. For example, if the vehicle is traveling on a one-way road, one unmanned aerial vehicle 704 may hover over the vehicle 700 and illuminate the vehicle 700 as described above. The other unmanned aerial vehicle 704 may place itself at a location behind the vehicle on the road and output light or self-illuminate such that any other vehicle driving behind the vehicle 700 on the one-way road can easily see the unmanned aerial vehicle 704, and locate the vehicle 700. In this instance, the second unmanned aerial vehicle 704, can act to create a buffer zone behind the vehicle 700 to prevent any other vehicle coming close to the vehicle 700. If the vehicle 700 is moving along a two-way street, one unmanned aerial vehicle 704 may be deployed to hover over the vehicle 700 and illuminate the vehicle, one unmanned aerial vehicle 704 may place itself in front of the vehicle 700, and a third unmanned aerial vehicle 704 may place itself behind the vehicle 700 on the road such that vehicles driving behind the vehicle 700 and vehicles in the oncoming traffic in the other direction can easily spot the third unmanned aerial vehicle 704 and locate the vehicle 700. In another embodiment, multiple unmanned aerial vehicles 704 may be deployed around the vehicle to direct the traffic to adjacent lanes, as illustrated in FIG. 7C.

The visual alert system 242 may automatically deploy one or more of the above-mentioned mechanisms upon determination that the vehicle 102 is disabled. In another embodiment, the driver of the vehicle 102 may trigger the visual alert system 242 (e.g., by activating a button or icon on the HMI system, etc.) based on determining that the vehicle is disabled. In other embodiments, the visual alert system may consider other factors, such as ambient lighting of the external environment around the car, to determine which type of visual alert mechanism is to be deployed or whether there is even a need to deploy any visual alert mechanism. For example, if the external environmental condition data indicates that it is a sunny day with good visibility, the vehicle 102 may not deploy any of the available visual alert mechanisms described above as the chances that the visual alert mechanisms will increase the visibility of the vehicle 102 are low. In other embodiments, the presence of street lighting and the illumination provided by the street lighting is also taken into consideration by the visual alert system 242 in determining which type of visual alert mechanism to deploy and how many instances of the visual alert mechanism are to be deployed. For example, if the illumination provided by the streetlight is greater than the illumination that may be provided by the visual alert mechanism, then the vehicle may decide not to deploy the visual alert mechanism.

Any of the above-mentioned visual alert mechanisms illustrated in FIGS. 4-7 may be used in a mutually exclusive manner or can be used in conjunction with each other depending on the nature of the disability, availability of the visual alert mechanisms, time of the day, weather data, and/or location data. Further, any of the above-mentioned visual alert mechanisms may be used with other existing alert mechanisms used by the first responders and can seamlessly integrate with the existing alert mechanisms. For example, upon receiving the information about the disabled vehicle, the tow-truck person or any other first responder entity can remotely activate the visual alert system 242 of the vehicle 102 while they are enroute to the location of the disabled vehicle. Once the first responder entity arrives at the location of the disabled vehicle, they can turn off or deactivate the visual alert system 242 and any associated visual alert mechanism that may be active at that time.

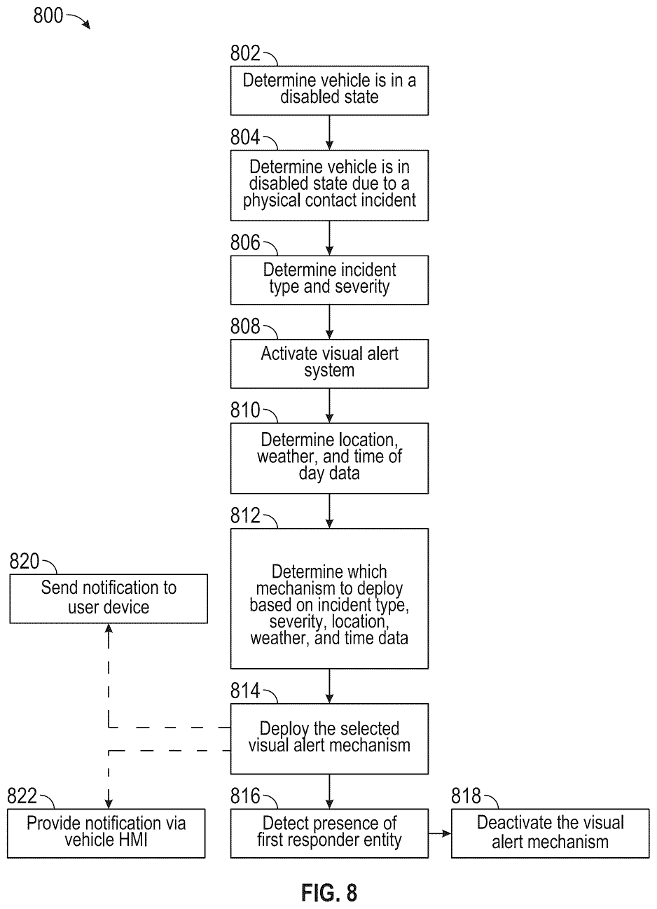

FIG. 8 illustrates a flow chart for a process 800 for improving the visibility of a vehicle according to an embodiment of the present disclosure. Process 800 may be performed, e.g., by the vehicle 102 of FIG. 1. At step 802, the vehicle may determine that it is in a disabled state. In an embodiment, the disabled state may be such that the vehicle is not drivable and/or self-movable from its current location. In an embodiment, the current location may be a lane of a high-traffic highway. At step 804, the vehicle determines that the vehicle was involved in an incident that included physical contact between the vehicle and another object. The other object may include another vehicle or any other object, such as a tree, a light pole, a road divider, a person, or the like. At step 806, the vehicle may determine the incident type and the severity of the incident. For example, an incident detection system of the vehicle may determine if a supplemental restraint system of the vehicle was activated, which would indicate the severity of the incident.

At step 808, the vehicle may activate the visual alert system. In another embodiment, the driver of the vehicle may activate the visual alert system. Once activated, the visual alert system may determine which visual alert system mechanism is to be deployed and whether multiple visual alert mechanisms need to be deployed, at step 812. In determining which visual alert mechanism needs to be deployed, the visual alert system may take into account the time of day, weather data, location data, and type and severity of the incident. Once the visual alert system has determined which visual alert mechanism is to be deployed and how many instances of the visual alert mechanism are to be deployed, the visual alert system then deploys the selected visual alert mechanism at step 814. Concurrently or after the deployment, the visual alert system may send a notification of the deployment to a user device associated with the driver (and the other occupants) of the vehicle and/or to the HMI system of the vehicle, at steps 820 and 822.

Thereafter, once a first responder entity arrives at the location to assist the vehicle and/or the occupants of the vehicle, the vehicle may determine presence of the first responder entity at step 816. Based on detecting the presence of the first responder entity, the vehicle may deactivate the deployed visual alert mechanism at step 818. For example, if the vehicle had activated the light emitting devices to illuminate the vehicle, the vehicle may turn off those light emitting devices. In another embodiment, the first responder entity may deactivate the visual alert mechanism.

As noted above, the vehicle 102 may activate/deploy the one or more visual alert mechanisms without any user intervention. In one instance, the vehicle may determine a state of one or more occupants of a vehicle. It is possible that the occupants of the vehicle are incapacitated due to an incident involving the vehicle 102. In this circumstance, the occupants of the vehicle may not be in a position to activate the visual alert mechanism(s). The vehicle may determine that the occupants of the vehicle are currently incapacitated (e.g., using one or more internal cameras of the vehicle), and based on that, the vehicle may automatically activate the one or more visual alert mechanisms described above. In other instances, where the occupants of the vehicle are able to activate the visual alert mechanism(s), the vehicle may provide a prompt on the user device and/or the HMI of the vehicle for the occupants of the vehicle to activate the visual alert mechanism(s).

FIG. 9 depicts a block diagram of an example control server 900 (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 900 may operate as a standalone device or may be connected (e.g., networked) to other servers. In a networked deployment, the server 900 may operate in the capacity of a server machine, a client machine, or both in server-client network environments. In an example, the server 900 may act as a peer server in peer-to-peer (P2P) (or other distributed) network environments. The server 900 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (Saas), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The server 900 may further include a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The server 900 may additionally include a storage device (i.e., drive unit) 916, a network interface device/transceiver 920 coupled to antenna(s), and one or more sensors 928, such as a global positioning system (GPS) sensor, a compass, an accelerometer, or other sensors. The server 900 may include an output controller 934, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 916 may include a machine-readable medium 922 on which is stored one or more sets of data structures or instructions (e.g., software) embodying or utilized by any one or more of the techniques or functions described herein. The instructions may also reside, completely or at least partially, within the main memory 904, within the static memory 906, or within the hardware processor 902 during execution thereof by the server 900. In an example, one or any combination of the hardware processor 902, the main memory 904, the static memory 906, or the storage device 916 may constitute machine-readable media.

While the machine-readable medium 922 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; a flash memory, etc.

The term “machine-readable medium” may include any medium that is capable of storing, encoding, or carrying instructions for execution by the server 900 and that causes the server 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendations or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not function.

It should also be understood that the word “example” as used herein is intended to be non-exclusionary and non-limiting in nature. More particularly, the word “example” as used herein, indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A method comprising:
determining, by a vehicle, that the vehicle is in a disabled state on a road;
determining, by the vehicle, a time of day;
determining, by the vehicle, location data associated with a current location of the vehicle;
determining, by the vehicle, a first visual alert mechanism to be deployed, from among a plurality of visual alert mechanisms based on the time of the day and the location data;
determining, by the vehicle, a state of one or more occupants of the vehicle; and
activating, by the vehicle, the first visual alert mechanism based on the state of the one or more occupants.

2. The method of claim 1, further comprising:
determining, by the vehicle, weather data associated with the time of the day and the location data; and
wherein determining the first visual alert mechanism is further based on the weather data.

3. The method of claim 1, further comprising:
determining, by the vehicle, that the vehicle is involved in a traffic incident;
determining, by the vehicle, a nature and a severity of the disabled state; and
wherein determining the first visual alert is further based on the nature and the severity of the disabled state.

4. The method of claim 3, wherein the traffic incident includes physical contact between the vehicle and an object.

5. The method of claim 1, wherein activating the first visual alert mechanism comprises:
activating one or more self-powered lights of the vehicle;
releasing a fluorescent material that covers one or more external portions of the vehicle;
activating one or more unmanned aerial vehicles; or
deploying a fluorescent balloon that is tethered to the vehicle.

6. The method of claim 5, wherein the one or more aerial vehicles are stored in the vehicle prior to the activation.

7. The method of claim 1, wherein activating the first visual alert mechanism comprises:
activating a first unmanned aerial vehicle stored in the vehicle;
causing the first unmanned aerial vehicle to hover over the vehicle; and
causing the first unmanned aerial vehicle to illuminate the vehicle.

8. The method of claim 7, further comprising:
activating a second unmanned aerial vehicle stored in the vehicle;
placing the second unmanned aerial vehicle in front of the vehicle or behind the vehicle on the road; and
illuminating the second unmanned aerial vehicle.

9. The method of claim 7, further comprising:
activating a second unmanned aerial vehicle and a third unmanned aerial vehicle, wherein the second unmanned aerial vehicle and the third unmanned aerial vehicle are stored in the vehicle;
placing the second unmanned aerial vehicle and the third unmanned aerial vehicle in front of the vehicle or behind the vehicle to direct traffic to an alternate lane of the road.

10. A vehicle comprising:
one or more processors;
a memory device coupled to the one or more processors; and
a visual alert system coupled to the one or more processors, wherein the memory device stores instructions that when executed by the one or more processors cause the vehicle to:
determine that the vehicle is in a disabled state on a road;
determine a time of day;
determine location data associated with a current location of the vehicle;
determine, via the visual alert system and based on the disabled state, the time of the day, and the location data, a first visual alert mechanism to be activated from among a plurality of visual alert mechanisms;
determine a state of one or more occupants of the vehicle; and
activate the first visual alert mechanism based on the state of the one or more occupants.

11. The vehicle of claim 10, further comprising an incident detection system, and wherein the one or processors are operable to execute the instructions to further cause the vehicle to:
determine, using the incident detection system, the vehicle is involved in a traffic incident; and
determine, using the incident detection system, a nature and a severity of the traffic incident;
wherein the vehicle further determines the first visual alert mechanism based on the nature and the severity of the traffic incident.

12. The system of claim 10, wherein the one or processors are operable to execute the instructions to further cause the vehicle to:
determine weather data associated with the location and the time of the day; and
wherein the vehicle further determines the first visual alert mechanism based on the weather data.

13. The vehicle of claim 10, wherein the plurality of visual alert mechanisms include:
one or more light emitting devices coupled to one or more external surfaces of the vehicle, wherein the one or more light emitting devices are self-powered;
one or more unmanned aerial vehicles stored in the vehicle;
a fluorescent material stored in one or more locations around the vehicle; or
a fluorescent balloon tethered to the vehicle.

14. The vehicle of claim 10, wherein the one or processors are operable to execute the instructions to further cause the vehicle to:
activate a second visual alert mechanism from among the plurality of visual alert mechanisms, wherein the second visual alert mechanism is a second instance of the first visual alert mechanism.

15. The vehicle of claim 10, wherein the one or processors are operable to execute the instructions to further cause the vehicle to:
activate a second visual alert mechanism from among the plurality of visual alert mechanisms, wherein the second visual alert mechanism is different than the first visual alert mechanism.

16. The vehicle of claim 10, wherein the one or processors are operable to execute the instructions to further cause the vehicle to:
determine presence of a first responder entity at the location; and
deactivate the first visual alert mechanism in response to detecting the presence of the first responder entity.

17. A method comprising:
determining, by a vehicle, that the vehicle is in a disabled state;
determining, by the vehicle, location data associated with a current location of the vehicle;
determining, by the vehicle, a time of the day;
selecting, by the vehicle, a first visual alert mechanism, from among a plurality of visual alert mechanisms of the vehicle, the selecting being based on the disabled state, the location data, and the time of the day and wherein the plurality of visual alert mechanisms include (i) one or more light emitting devices coupled to the vehicle that do not derive power from the vehicle, (ii) a fluorescent material stored at one or more locations within the vehicle, or (iii) one or more unmanned aerial vehicles stored in the vehicle;
determining, by the vehicle, a state of one or more occupants of the vehicle; and
activating, by the vehicle, the first visual alert mechanism based on the state of the one or more occupants.

18. The method of claim 17, further comprising:
determining, by the vehicle, weather data associated with the location and the time of the day; and
wherein selecting the first visual alert mechanism is further performed using the weather data.

19. The method of claim 17, wherein the one or more unmanned aerial vehicles include a first unmanned aerial vehicle and a second unmanned aerial vehicle, the method further comprising:
causing the first unmanned aerial vehicle to hover over the vehicle and direct light toward the vehicle; and
causing the second unmanned aerial vehicle to be located in front of the vehicle or behind the vehicle, wherein the second unmanned aerial vehicle is self-illuminated.

20. The method of claim 17, wherein activating the first visual alert mechanism further includes:
releasing the fluorescent material from the one or more locations; and
causing the fluorescent material to deposit over one or more external surfaces of the vehicle.

21. The method of claim 17, wherein determining the state of the one or more occupants of the vehicle comprises determining that the one or more occupants is incapacitated.
